(19) United States
(12) Patent Application Publication
(10) Pub. No.: US 2016/0358527 A1
(43) Pub. Date: Dec. 8, 2016

(54) DISPLAY DEVICE, DRIVER OF THE DISPLAY DEVICE, ELECTRONIC DEVICE INCLUDING THE DISPLAY DEVICE AND THE DRIVER, AND DISPLAY SYSTEM

(71) Applicant: SAMSUNG ELECTRONICS CO., LTD, Gyeonggi-do (KR)

(72) Inventors: Jong-kon Bae, Seoul (KR); Kwang-young Kim, Gyeonggi-do (KR); Yong-man Lee, Gyeonggi-do (KR); Dong-kyoon Han, Gyeonggi-do (KR)

(21) Appl. No.: 15/111,790

(22) PCT Filed: Jan. 14, 2015
(86) PCT No.: PCT/KR2015/000403

§ 371 Date: Jul. 14, 2016

(30) Foreign Application Priority Data
Jan. 14, 2014 (KR) 10-2014-0004695

(51) Int. Cl. G09G 3/20

(52) U.S. Cl. CPC G09G 3/2003; G09G 3/2096; G09G 2370/10; G09G 2330/021

(57) ABSTRACT

A display device includes: an application processor (AP) comprising an encoder for determining the repeatability of display data, generating conversion information, encoding the display data based on the conversion information, and generating encoded display data; and a display driver integrated circuit (IC) for receiving the encoded display data and driving a display panel.

### TECHNICAL FIELD

One or more embodiments of the present invention relate to a display device, a driver of the display device, an electronic device including the display device and the driver, and a display system, and more particularly, to a display device that operates at low power, a driver of the display device, an electronic device including the display device and the driver.

### BACKGROUND ART

Recently, according to the release of smart phones or tablet personal computers (PCs), including a display module having super resolution at a high resolution television (HDTV) level, a mobile display has been developed to a wide video graphics array (WVGA) level or a full HD level.

Here, since a display driving circuit processes an increased amount of data, a current amount used by the display driving circuit is gradually increasing. For example, a data throughput of a flat panel display device is increasing due to an increase in a frame rate and an increase in resolution.

### DISCLOSURE OF INVENTION

### Solution to Problem

One or more embodiments of the present invention include a display device that may operate at low power, a driver of the display device, an electronic device including the display device and the driver.

### Advantageous Effects of Invention

A display device that may operate at low power, a driver of the display device, an electronic device including the display device and the driver may be implemented.

### BRIEF DESCRIPTION OF DRAWINGS

FIG. 1 is a block diagram of an electronic device according to some embodiments of the present invention;

FIG. 2 is an exemplary diagram for explaining an operation of an encoder;

FIG. 3 is a diagram of a detailed configuration of the encoder;

FIG. 4 is a flowchart of an operation of an electronic device;

FIG. 5 is a timing diagram for explaining a detailed operation of an encoder, according to some embodiments of the present invention;

FIGS. 6 through 9 are tables illustrating encoded display data compressed in a packet structure;

FIGS. 10A and 10B illustrate headers having a packet structure in which display data for pixels included in one line is white;

FIG. 11 illustrates a header having a packet structure in which every display data for pixels included in one line is black;

FIG. 12 illustrates a header having a packet structure in which every display data for pixels included in one line is a specific gray value;

FIG. 13 illustrates a packet structure in which every display data for pixels included in one line repeats two gray values;

FIG. 14 illustrates a packet structure in which every display data for pixels included in one line repeats one color value and one white value;

FIG. 15 illustrates a packet structure in which one piece of line data repeats two specific color values;

FIG. 16 is a diagram for explaining a case where display data is repeated in a block unit;

FIG. 17 illustrates a packet structure in a case where display data is repeated in a block unit;

FIG. 18 illustrates a packet structure in a case where the number of pieces of repeated display data is more than a predetermined number according to some embodiments of the present invention;

FIG. 19 is a block diagram of an electronic device according to some embodiments of the present invention;

FIG. 20 is a block diagram of an electronic device according to some embodiments of the present invention;

FIG. 21 is a block diagram of an electronic device according to some embodiments of the present invention;

FIG. 22 illustrates a display system according to an embodiment of the present invention;

FIG. 23 is a block diagram of an electronic device according to another embodiment of the present invention;

FIG. 24 is a block diagram of a mobile terminal according to some embodiments of the present invention; and

FIG. 25 is a diagram of examples of various products on which an electronic device is mounted, according to some embodiments of the present invention.

### BEST MODE FOR CARRYING OUT THE INVENTION

Additional aspects will be set forth in part in the description which follows and, in part, will be apparent from the description, or may be learned by practice of the presented embodiments.

According to one or more embodiments of the present invention, an electronic device includes: an application processor (AP) including an encoder configured to determine repeatability of display data, to generate conversion information based on the repeatability of display data, to encode the display data based on the repeatability of display data, and to generate encoded display data with the conversion information; and a display driver integrated circuit (IC) configured to receive the encoded display data with the conversion information and to drive a display panel according to the encoded display data based on the conversion information.

According to one or more embodiments of the present invention, a display driver integrated circuit (IC) includes an encoder configured to determine repeatability of display data, to generate conversion information based on the repeatability of display data, to encode the display data based on the repeatability of display data, and to generate encoded display data with the conversion information, wherein the display driver IC receives the encoded display data with the conversion information and drives a display panel according to the encoded display data based on the conversion information.

According to one or more embodiments of the present invention, an image sensing device includes: an image sensor integrated circuit (IC) including an encoder configured to determine repeatability of display data collected via an image sensor, and to generate conversion information based on the repeatability of display data, to encode the display data based on the conversion information, and to generate encoded display data with the conversion information; and an application processor (AP) configured to receive the encoded display data.

According to one or more embodiments of the present invention, a communication device includes: an application processor (AP) including an encoder configured to determine the repeatability of display data, to generate conversion information based on the repeatability of display data, to encode the display data based on the conversion information, and to generate encoded display data with the conversion information; and a display driver integrated circuit (IC) configured to receive the encoded display data with the conversion information and driving a display panel based on the conversion information.

According to one or more embodiments of the present invention, a communication device includes: an image sensor integrated circuit (IC) including an encoder configured to determine the repeatability of display data collected via an image sensor, to generate conversion information based on the repeatability of display data, to encode the display data based on the conversion information, and to generate encoded display data with the conversion information; and an application processor (AP) configured to receive the encoded display data with the conversion information.

### MODE FOR THE INVENTION

This application claims the benefit of Korean Patent Application No. 10-2014-0004695, filed on Jan. 14, 2014, in the Korean Intellectual Property Office, the disclosure of which is incorporated herein in its entirety by reference.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, like reference numerals denote like elements, and the sizes and thicknesses of layers and regions are exaggerated for clarity.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “include”, “may include”, “have”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

While such terms as “first”, “second”, etc., may be used to describe various components, such components must not be limited to the above terms. The above terms are used only to distinguish one component from another. For example, a first component may be referred to as a second component, and similarly, a second component may be referred to as a first component without departing from the scope of the invention.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

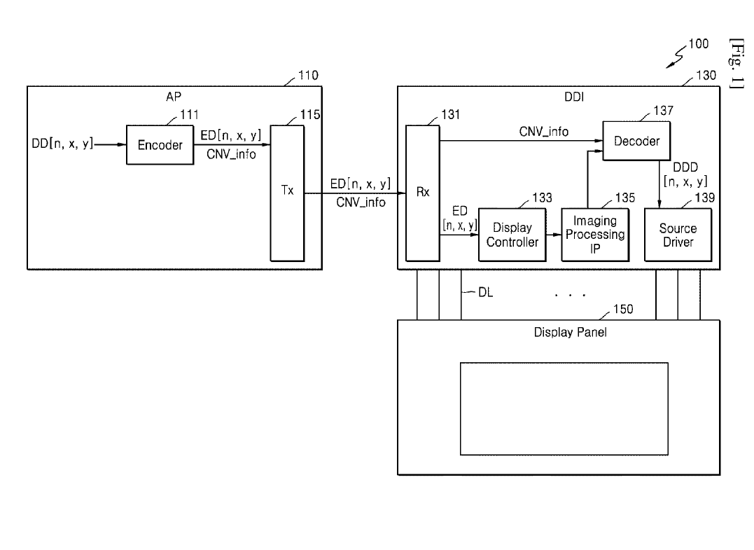

FIG. 1 is a block diagram of an electronic device 100 according to some embodiments of the present invention.

Referring to FIG. 1, the electronic device 100 may include an application processor (AP) 110, a display driver integrated circuit (IC) 130, and a display panel 150.

The electronic device 100 may be an electronic device having a display function or an electronic device having a communication function. For example, the electronic device 100 may be a laptop computer, a mobile phone, a smart phone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), or an e-book.

The AP 110 may generally control the electronic device 100.

The AP 110 may include at least one AP or at least one communication processor (CP) (not shown).

For example, in the AP 110, an AP and a CP may be included in one IC package or in different IC packages.

The AP 110 may drive an operating system or an application program to control a plurality of hardware or software components connected to the AP 110, and may perform various data processes and operations including multimedia data. The AP 110 may be realized, for example, in a system-on-chip (SoC). According to an embodiment, the AP 110 may further include a graphics processing unit (GPU) (not shown).

When the electronic device 100 has a communication function, the AP 110 may perform local area communication, determine location information of the electronic device 100, receive a broadcast, access wireless Internet, and recognize a user input.

The AP 110 may include an encoder 111 and a transmission unit 115.

As described above, a display device that may operate at low power, a driver of the display device, an electronic device including the display device and the driver may be implemented.

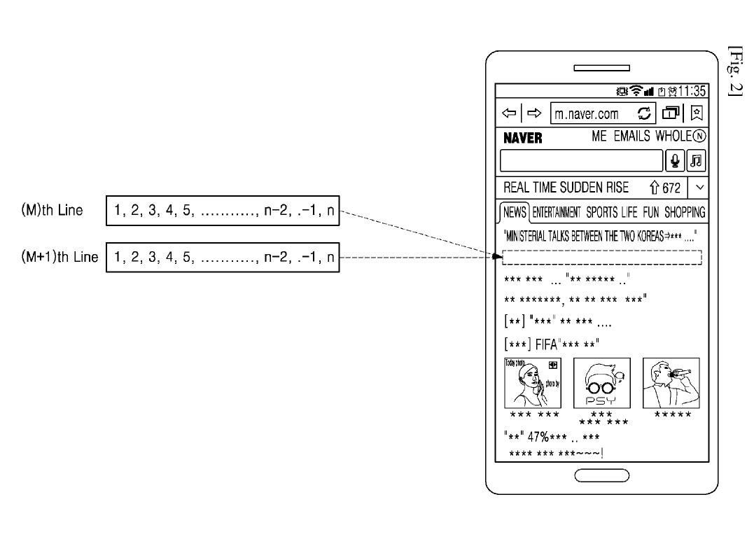

FIG. 2 is an exemplary diagram for explaining an operation of the encoder 111.

Referring to FIG. 2, it may be seen that pixels that form pure white may be continuously repeated on an Internet screen of an electronic device. For example, it is assumed that first through nth pixels of an Mth pixel line form pure white, and first through nth pixels of an M+1th pixel line also form pure white.

In this case, if the M+1th pixel line generates data meaning simply repeating the Mth pixel line while generating display data of the first pixel of the M+1th pixel line, the size of a signal of the M+1th pixel line may be reduced. The encoder 111 may determine how the display data is repeated between frames, pixel lines, and blocks. The encoder 11 may also encode the display data based on a form of the repeated display data between frames, pixel lines, and blocks.

Referring to FIG. 1, the encoder 11 may receive display data DD[n,x,y] (n denotes a serial number of frames, lines, or blocks, and x and y denote a pixel address value) of each frame and determine the repeatability of the received display data. The encoder 111 may determine the repeatability of the display data and generate conversion information CNV_info.

The encoder 111 may determine whether the current display data DD[n,x,y] repeats display data DD[n−1,x,y] of a previous frame, line, and block and generate the conversion information CNV_info

For example, it is assumed that the display panel 150 includes 100 pixels for one line. When pieces of display data (DD[1,1,1] through DD[1,100,1]) for pixels of first lines ([1,1] through [100,1]) of a first frame are pure white (R, G, B=255, 255, 255), and pieces of display data (DD[1,1,2] through DD[1,100,2]) for pixels of second lines ([1,2] through [100,2]) of the first frame are pure white (R, G, B=255, 255, 255), the encoder 111 may determine that the second lines ([1,2] through [100,2]) of the first frame repeats the pieces of display data (DD[1,1,1] through DD[1,100,1]) of the first lines ([1,1] through [100,1]) of the first frame. In this case, the encoder 111 may generate the conversion information CNV_info as, for example, 0 or 1.

When the pieces of display data DD[1,1,1] through DD[1,100,1] for pixels of the first lines [1,1] through [100,1] of a first frame are pure white (R, G, B=255, 255, 255), and the pieces of display data DD[1,1,2] through DD[1,100,2] for pixels of the second lines [1,2] through [100,2] of the first frame are pure black (R, G, B=0, 0, 0), the encoder 111 may determine that the second lines [1,2] through [100,2] of the first frame do not repeat the pieces of display data DD[1,1,1] through DD[1,100,1] of the first lines [1,1] through [100,1] of the first frame. In this case, the encoder 111 may generate the conversion information CNV_info as, for example, 1 or 0.

The encoder 111 may determine whether the display data DD[n,x,y] repeats the display data DD[n−1,x,y] having a difference below a reference value from the previous frame, line, and block.

For example, it is assumed that the display panel 150 includes 100×100 pixels for one frame and that a difference below the reference value is a difference below 10 units in an 8-bit 256-color with respect to display data of each RGB. When pieces of display data DD[1,1,1] through DD[1,10,10] for pixels of a first block [1,1] through [10,10] of a first frame are pure white (R, G, B=255, 255, 255) and pieces of display data DD[1,11,1] through DD[1,20,10] for pixels of a second block [11,1] through [20,10] of the first frame are gray (R, G, B=250, 250, 250), which closer to white color value than black color value, the encoder 111 may determine that the second blocks [11,1] through [20,10] of the first frame repeats the pieces of display data DD[1,1,1] through DD[1,10,10] of the first block [1,1] through [10,10] of the first frame.

When the pieces of display data DD[1,1,1] through DD[1,10,10] for pixels of the first block [1,1] through [10,10] of the first frame are pure white (R, G, B=255, 255, 255), and the pieces of display data DD[1,11,1] through DD[1,20,10] for pixels of the second block [11,1] through [20,10] of the first frame are gray (R, G, B=230, 230, 230) having a difference (for example, of 25 units with respect to each RGB) greater than the reference value, the encoder 111 may determine that the second block [11,1] through [20,10] of the first frame do not repeat the pieces of display data DD[1,1,1] through DD[1,10,10] of the first block [1,1] through [10,10] of the first frame.

The encoder 111 may generate the conversion information CNV_info by determining whether display data is the same between a plurality of pixel groups having the same size. That the pixel groups have the same size may mean that the number of pixels of the pixel groups in a vertical direction and the number thereof in a horizontal direction are the same.

In this regard, pixels included in one pixel group may be included in a same horizontal or vertical line. The pixels included in one pixel group may be included in a same frame. The pixels include in one pixel group may be included in a block including N number of horizontal pixels and M number of vertical pixels.

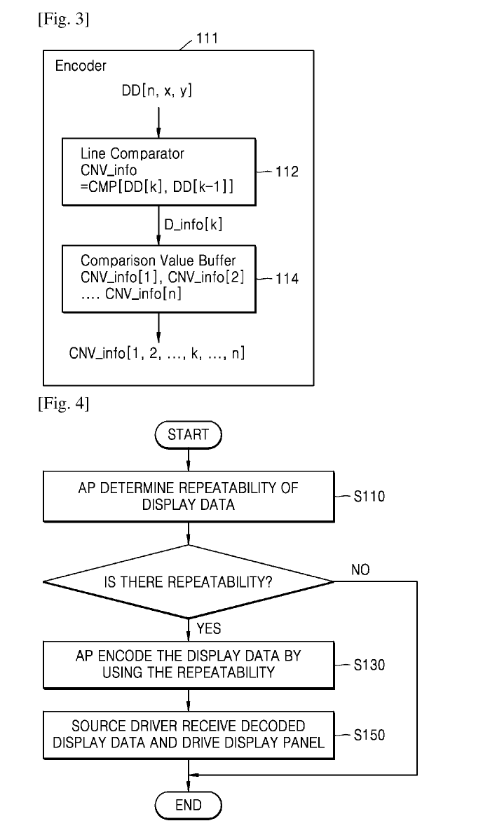

FIG. 3 is a diagram of a detailed configuration of the encoder 111.

Referring to FIG. 3, the encoder 111 may include a line comparator 112 and a comparison value buffer 114.

The line comparator 112 may generate conversion information CNV_info[k] for each of the lines corresponding to, for example, two frames f[k] and f[k−1]. The line comparator 112 may generate the conversion information CNV_info[k] for, for example, two lines l[k] and l[k−1]. The line comparator 112 may generate the conversion information CNV_info[k] for each of the lines corresponding to, for example, two blocks b[k] and b[k−1].

The line comparator 112 may generate the conversion information CNV_info[k] for a kth line by determining whether display data of the kth line is the same as that of a k−1th line.

The line comparator 112 may generate the conversion information CNV_info[k] for the kth line by determining whether the display data of the kth line is the same as that of a 1st line through the k−1th line.

The comparison value buffer 114 may store conversion information CNV_info[1, 2, . . . k, . . . n] generated by the line comparator 112.

Referring to FIG. 1, the encoder 111 may generate the conversion information CNV_info by determining whether RGB data values are repeated between the pixel groups having the same size.

For example, it is assumed that display data (R, G, B=100, 130, 150) is the same between a plurality of pixels included in a first line. In this case, the encoder 111 may generate a signal indicating that a previous pixel value is not repeated by a first pixel value included in the first line. The encoder 111 may generate a signal indicating that the first pixel value is repeated by a second pixel value included in the first line. Continuously, the encoder 111 may generate a signal indicating that the second pixel value is repeated by a third pixel value included in the first line.

In this regard, it is assumed that the display data (R, G, B=100, 130, 150) is the same between a plurality of pixels included in a second line subsequent to the first line. In this case, the encoder 111 may generate a signal indicating that display data of the first line is repeated by the second line.

In another embodiment, the encoder 111 may generate conversion information by determining whether a gray data value is repeated between pixel groups having the same size.

For example, it is assumed that display data (R, G, B=100, 100, 100) is the same between a plurality of pixels included in a first line. In this case, the encoder 111 may generate a signal indicating that a previous pixel value is not repeated by a first pixel value included in the first line. The encoder 111 may generate a signal indicating that the first pixel value is repeated by a second pixel value included in the first line. Continuously, the encoder 111 may generate a signal indicating that the second pixel value is repeated by a third pixel value included in the first line.

In this regard, it is assumed that the display data (R, G, B=100, 100, 100) is the same between a plurality of pixels included in a second line subsequent to the first line. In this case, the encoder 111 may generate a signal indicating that display data of the first line is repeated by the second line.

The encoder 111 may generate encoded display data ED[n,x,y] by receiving the display data DD[n,x,y] and the conversion information CNV_info. For example, the encoder 111 may generate the encoded display data ED[n,x,y] by encoding the display data DD[n,x,y] based on repeatability information of a pixel corresponding to corresponding pixel, line, block, or frame included in the conversion information CNV_info. The encoder 111 may generate the encoded display data ED[n,x,y] in packet form.

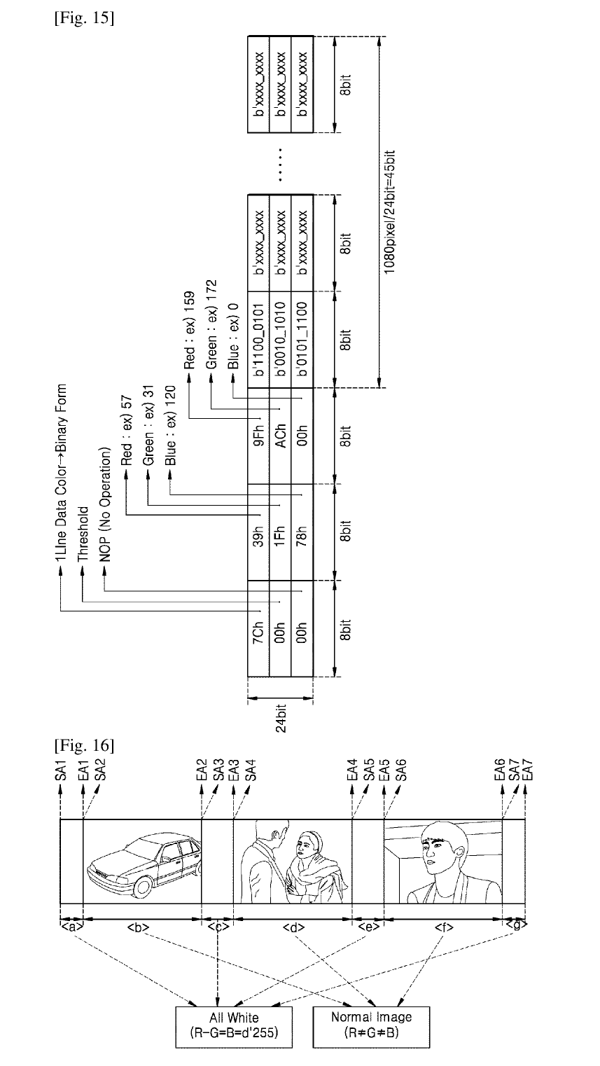

For example, when the encoder 111 determines that a second line of a first frame repeats display data of a first line of the first frame and generates the conversion information CNV_info including such information, the encoder 111 may generate the encoded display data ED[n,x,y] for a first pixel of the second line of the first frame such that the encoded display data ED[n,x,y] may include content that the second line repeats the first line. A detailed description of an encoding method will be provided with reference to FIGS. 15 through 17.

The transmission unit 115 may transmit the conversion information CNV_info and the encoded display data ED[n,x,y] that are generated by the encoder 111 to the display driver IC 130.

The display driver IC 130 may include a receiving unit 131, a display controller 133, an imaging processing IP 135, a decoder 137, and a source driver 139.

The receiving unit 131 may receive the conversion information CNV_info and the encoded display data ED[n,x,y] that are transmitted by the transmission unit 115. The display driver IC 130 may drive the display panel 150 by using the conversion information CNV_info and the encoded display data ED[n,x,y] that are received by the receiving unit 131.

The display controller 133 may apply the encoded display data ED[n,x,y] to a gate driver (not shown) and the source driver 139 based on a synchronization signal. For example, the display controller 133 may control the gate driver (not shown) and the source driver 139 based on the synchronization signal by receiving decoding data DD[n,x,y] from the decoder 137.

The imaging processing IP 135 performs necessary signal processing by using digital encoded display data. Signal processing may include color interpolation, color correction, auto white balance, gamma correction, color saturation correction, formatting, bad pixel correction, hue correction, and the like. Although not shown, for example, the imaging processing IP 135 may perform various kinds of signal processing by receiving the decoding data DD[n,x,y] from the decoder 137. For example, the decoder 137 may generate the decoding data DD[n,x,y] by receiving the conversion information CNV_info and decoding the encoded display data ED[n,x,y] by referring to the conversion information CNV_info.

The source driver 139 may receive the decoding data DD[n,x,y]. The source driver 139 may transmit voltage signals corresponding to the display data to the display panel 150 via data lines DL by using gamma voltages output from a gamma circuit.

For example, operations of pixels of the display panel 150 are controlled by control of the source driver 139, and thus an image corresponding to the display data transmitted from an AP may be displayed on the display panel 150. Although one source driver 139 is exemplary illustrated in FIG. 1, the number of source drivers may vary according to applied embodiments.

Although the display driver IC 130 is included in one electronic device 100 with the AP 110 in the present embodiment, the display driver IC 130 may be included in an electronic device (not shown) separately from the AP 110 in another embodiment

The display panel 150 includes a thin-film transistor-liquid crystal display (TFT-LCD), a light-emitting diode (LED) display, an organic LED (OLED) display, an active-matrix OLED (AMOLED) display, a flexible display, or any other type of flat-panel display. The display panel 150 may be, for example, flexible, transparent, or wearable. The display panel 140 may form one module with a touch panel.

The display panel 150 may be replaced by a hologram unit that realizes a stereoscopic image in the air by using interference of light. The display panel 150 may be replaced by a projector that displays an image by projecting light on a screen. The screen may be located inside or outside the electronic device 100.

A plurality of pixels included in the display panel 150 may each have a pentile structure including one red sub-pixel, one blue sub-pixel, and two green sub-pixels. The plurality of pixels included in the display panel 150 may each include at least one of red, green, blue, and white sub-pixels. The plurality of pixels included in the display panel 150 may have any one of various configurations and shapes.

The electronic device 100 according to some embodiments may encode the display data DD[n,x,y] by using the AP 110 and transmit a relatively small amount of data to the display driver IC 130. The electronic device 100 may reduce power consumed to transmit the data.

For example, the display driver IC 130 may include a decoder 137 that reconstructs the encoded display data ED[n,x,y] corresponding to the conversion information CNV_info and a source driver 139 that receives the display data reconstructed by the decoder 137.

For example, the encoder 111 may generate the conversion information CNV_info by determining whether the display data is the same between a plurality of pixel groups having a same size.

For example, the encoder 111 may determine that the display data is the same between the pixel groups when the pieces of display data of the pixel groups having the same size have a difference below a reference value.

For example, the pixel groups may be pixel groups of a same line, pixel groups of a same frame, or pixel groups including pixel blocks including N number of horizontal pixels and M number of vertical pixels.

For example, the encoded display data ED[n,x,y] may include a command including at least one of data regarding a repeated pixel, whether to repeat a pixel, and a repeating method, and a header including a parameter including the data regarding the repeating method.

For example, the parameter may include data as to whether display data of a first pixel repeats display data of a second pixel neighboring the first pixel.

For example, the encoded display data ED[n,x,y] may include a body including data regarding display data that is not included in the header for each pixel.

For example, the parameter may include the data as to whether the display data of the first pixel repeats the display data of the second pixel neighboring the first pixel. The body may include the display data of the first pixel when the display data of the first pixel does not repeat the display data of the second pixel neighboring the first pixel.

For example, the encoded display data ED[n,x,y] may include a tail including a parity check code for checking completeness of the encoded display data ED[n,x,y].

For example, the encoder 111 may include a line comparator that generates the conversion information CNV_info for each line and a comparison value storage unit that stores a result of the determination of the line comparator.

For example, the line comparator may generate conversion information for an nth line by determining whether display data of the nth line and display data of an n−1th line are the same. The comparison value storage unit may display whether display data of the nth line and display data of the n−1th line are the same on the conversion information for the nth line.

For example, the line comparator may generate the conversion information CNV_info for the nth line by determining whether the display data of the nth line and the display data of the n−1th line are the same. The comparison value storage unit may record an address value of a line of which display data is the same as the display data of the nth line on the conversion information for the nth line.

For example, the encoder 111 may generate the conversion information CNV_info for blocks having a same size, determine whether display data of a first block and display data of a second block are the same, and generate conversion information for the first block.

For example, the encoded display data ED[n,x,y] may include data regarding a start point of the first block and an end point of the first block.

For example, the encoder 111 may generate the conversion information CNV_info by determining whether an RGB data value is repeated between a plurality of pixel groups of a same size.

For example, the encoded display data ED[n,x,y] may include data including the repeated RGB data value and a repeating section.

For example, the pixel groups of the same size may belong to a same frame.

For example, the encoder 111 may generate the conversion information CNV_info by determining whether same display data is repeated between the pixel groups of the same size including gray display data.

For example, the encoded display data ED[n,x,y] may include data including a repeated gray display data value and a repeating section.

For example, the pixel groups of the same size may belong to a same frame.

FIG. 4 is a flowchart of an operation of the electronic device 100.

Referring to FIG. 4, the AP 110 (for example, the encoder 111) determines the repeatability of display data (operation S 110). As described with reference to FIG. 1 above, the repeatability may be determined between frames, between pixel lines, and between blocks. As described with reference to FIG. 1 above, the AP 110 (for example, the encoder 111) may determine whether an RGB signal and a gray signal are repeated. The AP 110 (for example, the encoder 111) may determine whether the display data having a difference below a reference value is repeated. An exemplary configuration of the AP 110 (for example, the encoder 111) may include the line comparator 112 and the comparison value buffer 114, as shown in FIG. 3 above.

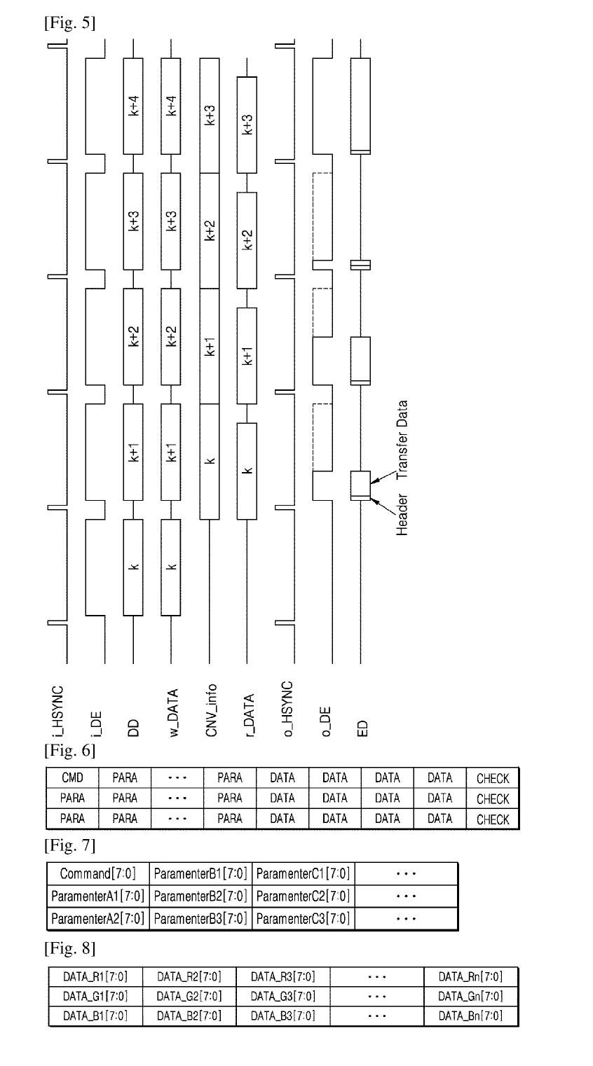

The encoder 111 encodes the display data by using the repeatability when the repeatability of the display data is determined (operation S 130). A detailed encoding method will be described with reference to FIGS. 5 through 17. A source driver may receive decoded display data and drive a display panel (operation S 150).

FIG. 5 is a timing diagram for explaining a detailed operation of an encoder, according to some embodiments of the present invention.

Referring to FIGS. 1 and 5, the AP 110 may generate an input horizontal sync signal i_HSYNC and an input data enable signal i_DE such that display data DD may be synchronized with the input horizontal sync signal i_HSYNC and the input data enable signal i_DE. The encoder (111 of FIG. 1) may receive the display data DD. The AP 110 may record recording data w_DATA on a buffer (not shown) simultaneously with an input of the display data DD. The AP 110 may generate readout data r_DATA by reading out the recording data w_DATA from the buffer. The AP 110 may generate the conversion information CNV_info by reading out the readout data r_DATA and determining the repeatability of data. The AP 110 may encode the display data DD based on the conversion information CNV_info and generate encoded display data ED. The AP 110 may output the encoded display data ED from the encoder (111 of FIG. 1) by synchronizing the encoded display data ED with an output horizontal sync signal o_HSYNC and an output data enable signal o_DE. In this case, a signal length in the encoded display data ED may be smaller than that in the input display data DD.

FIGS. 6 through 9 are tables illustrating the encoded display data ED compressed in a packet structure.

Referring to FIG. 6, the encoded display data ED may include a header, a body, and a tail. One box may indicate a digital signal of each unit bit (for example, 8 bits). The encoder 111 of FIG. 1 may use the packet structure of FIG. 6 while compressing the display data DD. A detailed structure of each packet will be described below.

Referring to FIG. 7, the header may include a command CMD and a parameter PARA. The command CMD may include at last one of data regarding a repeated pixel, whether to repeat a pixel, and a repeating method. The command CMD may include content, for example, that a kth pixel line repeats a k−2th pixel line. The command CMD may include content, for example, that the kth pixel line includes a same gray signal.

The parameter PARA may include the data regarding the repeating method. For example, the parameter PARA may include content that the kth pixel line is repeated as a specific gray value (for example, white). For example, the parameter PARA may include a value in a range of an error of an RGB signal that is regarded as the same. For example, the parameter PARA may include data as to whether display data of a first pixel repeats display data of a neighboring second pixel.

Referring to FIG. 8, the body may include data regarding display data that is not included in the header for each pixel. In this regard, the data regarding the display data that is not included in the header may include information that is not repeated. For example, the data regarding the display data that is not included in the header may mean information as to whether each pixel includes a specific RGB value. For example, the body may include the display data of the first pixel only when the display data of the first pixel does not repeat the display data of the second pixel.

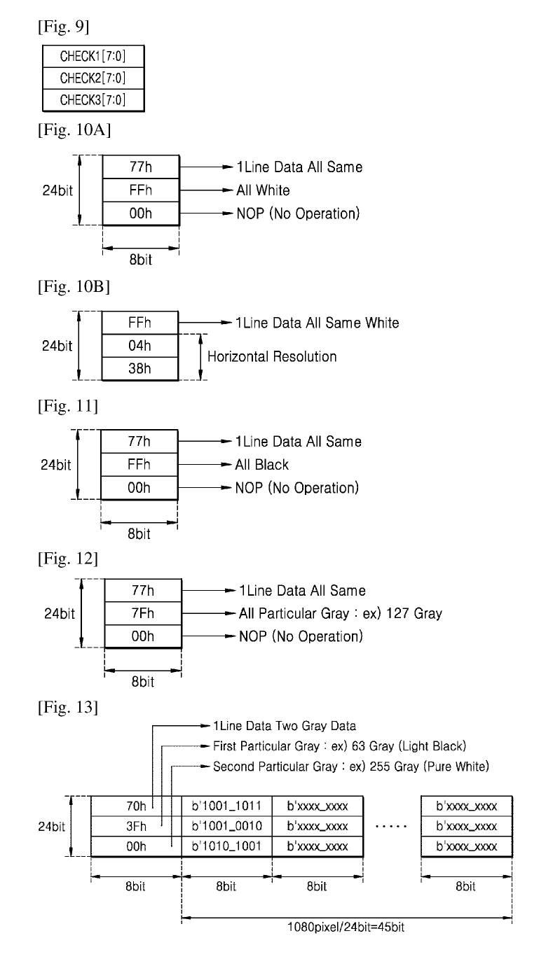

Referring to FIG. 9, the tail may include a parity check code for checking completeness of the encoded display data ED. The tail may include a parity check code for determining whether, for example, an error has occurred in data transmission.

FIGS. 10A and 10B illustrate headers having a packet structure in which all display data for pixels included in one line is white.

Referring to FIG. 10A, the command CMD is an 8-bit signal that means that one piece of line data is the same. A first parameter is an 8-bit signal that means that one piece of line data is white. A second parameter may include a Null signal.

Referring to FIG. 10B, the command CMD is an 8-bit signal that means that one piece of line data is white. In this case, the first parameter and the second parameter may include a signal regarding a resolution.

FIG. 11 illustrates a header having a packet structure in which all display data for pixels included in one line is black.

Referring to FIG. 11, the command CMD is an 8-bit signal that means that one piece of line data is the same. A first parameter is an 8-bit signal that means that one piece of line data is black. A second parameter may include a Null signal.

FIG. 12 illustrates a header having a packet structure in which all display data for pixels included in one line is a specific gray value.

Referring to FIG. 12, the command CMD is an 8-bit signal that means that one piece of line data is the same. A first parameter is an 8-bit signal that means that one piece of line data is the specific gray value (for example, 127 Gray). A second parameter may include a Null signal.

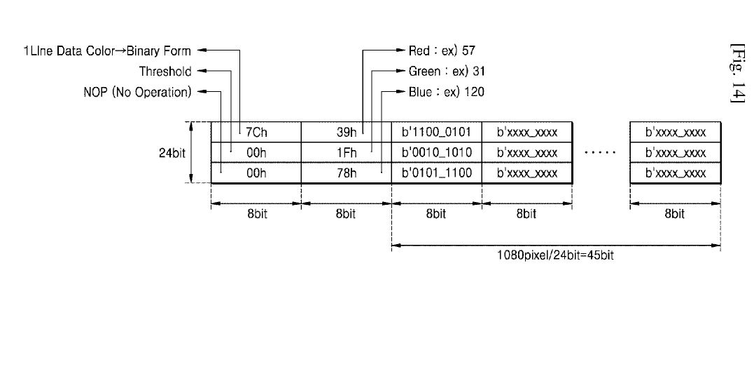

FIG. 13 illustrates a packet structure in which all display data for pixels included in one line repeats two gray values.

Referring to FIG. 13, the command CMD is an 8-bit signal that means that one piece of line data repeats two gray values. A first parameter may indicate a specific gray value (for example, 63 Gray Light Black) expressed in a pixel when the first parameter is expressed as a binary signal of 1 in a body. A second parameter may indicate a specific gray value (for example, Pure White) expressed in a pixel when the second parameter is expressed as a binary signal of 0 in the body.

FIG. 14 illustrates a packet structure in which all display data for pixels included in one line repeats one color value and white.

Referring to FIG. 14, the command CMD is an 8-bit signal that means that one piece of line data repeats one color value and white. A first parameter may indicate a range of a color value (a reference value in the description with reference to FIG. 1) that is determined to be the same as a reference color value. A second parameter may include a Null signal. Third through fifth parameters may indicate specific color values (for example, RGB=39,1F,78) expressed in a pixel when expressed as a binary signal of 1 in a body.

FIG. 15 illustrates a packet structure in which one piece of line data repeats two specific color values.

Referring to FIG. 15, the command CMD is an 8-bit signal that means that one piece of line data repeats two specific color values. A first parameter may indicate a range of a color value (a reference value in the description with reference to FIG. 1) that is determined to be the same as a reference color value. A second parameter may include a Null signal. Third through fifth parameters may indicate specific color values (for example, RGB=39,1F,78) expressed in a pixel when expressed as a binary signal of 1 in a body. Sixth through eighth parameters may indicate specific color values (for example, RGB=9F,AC,00) expressed in a pixel when expressed as the binary signal of 1 in the body.

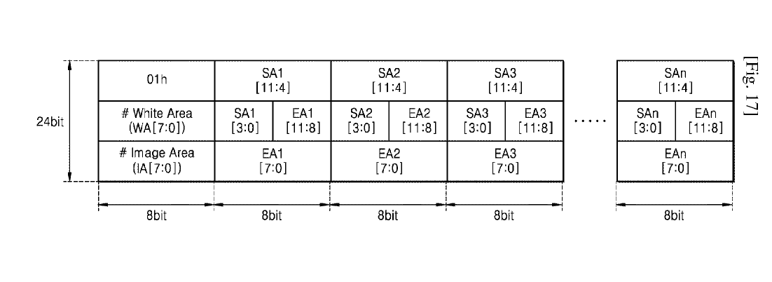

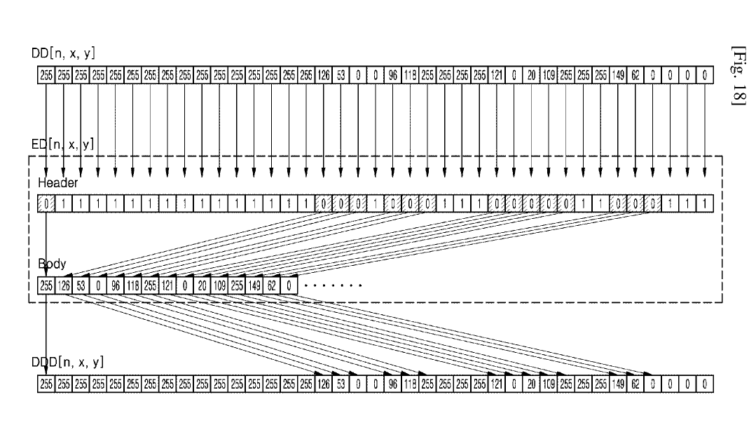

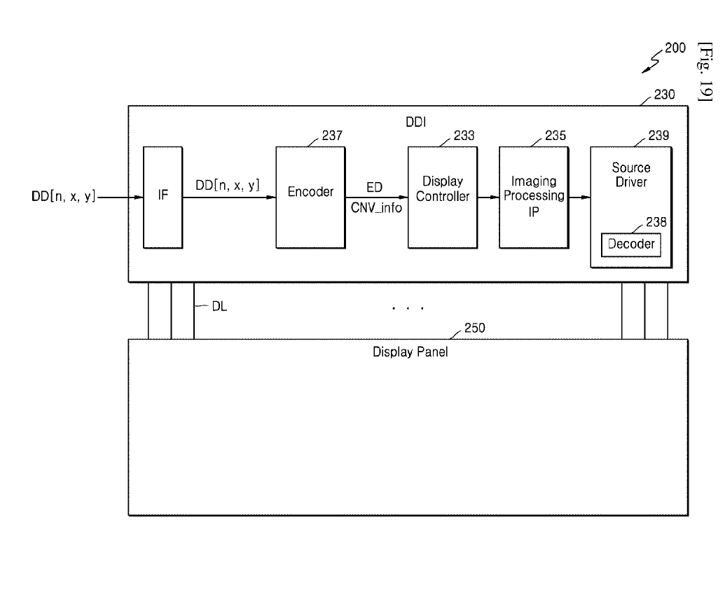

FIG. 16 is a diagram for explaining a case where display data is repeated in a block unit.

Referring to FIG. 16, display data of a first block a, a third block c, a fifth block e, and a seventh block g is white. A second block b, a fourth block d, and a sixth block f include display data each implementing an object.

FIG. 17 illustrates a packet structure in a case where display data is repeated in a block unit.

Referring to FIG. 17, the command CMD is an 8-bit signal meaning that display data of blocks is divided into blocks implementing white and blocks implementing objects. A first parameter may indicate the number of blocks implementing white. A second parameter may indicate the number of blocks implementing the objects. Parameters after a third parameter may display address values of start points (SA1[11:4], SA1[3:0], SA2[11:4], SA2[3:0], SA3[11:4], SA3[3:0]) and end points (EA1[11:8], EA1[7:0], EA2[11:8], EA2[7:0], EA3[11:8], EA3[7:0],) of the blocks implementing white. Although the address values of the start and end points are expressed as 12 bit, the size of data assigned to the address values of the start and end points may be various according to another embodiment (for example, 8 bit or 16 bit)

FIG. 18 illustrates a packet structure in a case where the number of pieces of repeated display data is more than a predetermined number according to some embodiments of the present invention.

Referring to FIG. 18, for example, when a value of display data corresponding to a first pixel is the same as that of display data corresponding to a second pixel, an encoder may map a header of the encoded display data ED[n,x,y] corresponding to the second pixel to, for example, 1. For example, when the value of the display data corresponding to the first pixel is not the same as that of the display data corresponding to the second pixel, the encoder may map the header of the encoded display data ED[n,x,y] corresponding to the second pixel to, for example, 0.

For example, data corresponding to each of the pixels of the display data DD[n,x,y] may be [255, 255, 255, 255 . . . 126, 53, 0, 0, 96, 118 . . . ], as shown in FIG. 18.

For example, data of a header corresponding to each of the pixels of the encoded display data ED[n,x,y] may be [0, 1, 1, 1 . . . 0, 0, 0, 1, 0, 0 . . . ], as shown in FIG. 18.

For example, when the display data corresponding to the first pixel does not repeat the display data corresponding to the second pixel, a body may include the display data corresponding to the first pixel. For example, a body of the encoded display data ED[n,x,y] may include the display data DD[n,x,y] for, for example, a value mapped to 0 in the header.

For example, data of the body of the encoded display data ED[n,x,y] may include [255, 126, 53, 0, 96, 118].

When, for example, a header of the encoded display data ED[n,x,y] is mapped to 0, a decoder may generate the decoded display data DDD[n,x,y] by referring to the data included in the body. When the header of the encoded display data ED[n,x,y] is mapped to 1, the decoder may generate the decoded display data DDD[n,x,y] by repeating the decoded display data DDD[n,x−1,y] of a neighboring pixel.

In some embodiments of the present invention, the encoder may generate the display data DD[n,x,y] by determining the repeatability for each sub-pixel. In some embodiments of the present invention, the encoder may generate the display data DD[n,x,y] by determining the repeatability for sub-pixels of each of red R, green G, and blue B.

In some embodiments of the present invention, when the number of repeated pixels of the display data DD[n,x,y] is more than a predetermined value, the encoder may generate the encoded display data ED[n,x,y] by using the method described with reference to FIG. 18, and, when the number of repeated pixels of the display data DD[n,x,y] is less than the predetermined value, the encoder may generate the encoded display data ED[n,x,y] by using another method.

FIG. 19 is a block diagram of an electronic device 200 according to some embodiments of the present invention.

Referring to FIG. 19, similar to the electronic device 100 of FIG. 1, the electronic device 200 may be included an electronic device having a display function or an electronic device having a communication function.

The electronic device 200 may include a display driver IC 230 and a display panel 250.

The display driver IC 230 may include an encoder 237, a display controller 233, an imaging processing IP 235, and a source driver 239.

The encoder 237 may receive the display data DD[n,x,y] (n denotes a serial number of a frame, a line, or a block, and x and y denote pixel address values) of each frame and determine the repeatability of the display data DD[n,x,y]. The encoder 237 may generate the conversion information CNV_info by determining the repeatability of the display data DD[n,x,y].

The encoder 237 may determine whether the current display data DD[n,x,y] repeats the display data DD[n−1,x,y] of a previous frame, line, and block and generate the conversion information CNV_info. An operation of the encoder 237 is similar to that of the encoder 111 of FIG. 1.

The encoder 237 may determine whether the display data DD[n,x,y] repeats the display data DD[n−1,x,y] having a difference below a reference value from the previous frame, line, and block.

The encoder 237 may generate the conversion information CNV_info by determining whether display data is the same between a plurality of pixel groups having the same size.

The encoder 237 may generate the conversion information CNV_info by determining whether data values are repeated between the pixel groups having the same size. In another embodiment, the encoder 237 may generate the conversion information CNV_info by determining whether a gray data value is repeated between pixel groups having the same size.

The encoder 237 may generate the encoded display data ED[n,x,y] by receiving the display data DD[n,x,y] and the conversion information CNV_info. For example, the encoder 237 may generate the encoded display data ED[n,x,y] by encoding the display data DD[n,x,y] based on repeatability information of a corresponding pixel, line, block, or frame included in the conversion information CNV_info. The encoder 237 may generate the encoded display data ED[n,x,y] in packet form.

The display controller 233 may apply the encoded display data ED[n,x,y] to a gate driver (not shown) and the source driver 239 based on a synchronization signal.

The imaging processing IP 235 performs necessary signal processing by using digital encoded display data. Signal processing may include color interpolation, color correction, auto white balance, gamma correction, color saturation correction, formatting, bad pixel correction, hue correction, and the like.

The source driver 239 may include a decoder 238. The decoder 238 may receive the encoded display data ED[n,x,y] on which signal processing has been performed via various methods from the imaging processing IP 235 and generate the decoded display data DDD[n,x,y]. For example, the decoder 238 may generate the decoded display data DDD[n,x,y] by receiving the conversion information CNV_info and decoding the encoded display data ED[n,x,y] by referring to the conversion information CNV_info.

The source driver 239 may transmit the decoded display data DDD[n,x,y]] and voltage signals corresponding to the display data to the display panel 250 via data lines DL by using gamma voltages output from a gamma circuit.

The electronic device 200 according to some embodiments may encode the display data DD[n,x,y] by using the display driver IC 230 and use a relatively small amount of data in the display driver IC 230. The electronic device 200 may reduce power consumed in the display driver IC 230.

For example, the encoder 237 may generate the conversion information CNV_info by determining whether the display data is the same between a plurality of pixel groups having a same size.

For example, the encoder 237 may determine that the display data is the same between the pixel groups when the pieces of display data of the pixel groups having the same size have a difference below a reference value.

For example, the pixel groups may be pixel groups of a same line, pixel groups of a same frame, or pixel groups including pixel blocks including N number of horizontal pixels and an M number of vertical pixels.

For example, the encoded display data ED[n,x,y] may include a command including at least one of data regarding a repeated pixel, whether to repeat a pixel, and a repeating method, and a header including a parameter including the data regarding the repeating method.

For example, the parameter may include data as to whether display data of a first pixel repeats display data of a second pixel neighboring the first pixel.

For example, the encoded display data ED[n,x,y] may include a body including data regarding display data that is not included in the header for each pixel.

For example, the parameter may include the data as to whether the display data of the first pixel repeats the display data of the second pixel neighboring the first pixel. The body may include the display data of the first pixel when the display data of the first pixel does not repeat the display data of the second pixel neighboring the first pixel.

For example, the encoder 237 may include a line comparator that generates the conversion information CNV_info for each line and a comparison value storage unit that stores a result of the determination of the line comparator.

For example, the line comparator may generate conversion information for an nth line by determining whether display data of the nth line and display data of an n−1th line are the same. The comparison value storage unit may display whether display data of the nth line and display data of the n−1th line are the same on the conversion information for the nth line.

For example, the encoder 237 may generate the conversion information CNV_info for blocks having a same size, determine whether display data of a first block and display data of a second block are the same, and generate conversion information for the first block.

For example, the encoded display data ED[n,x,y] may include data regarding a start point of the first block and an end point of the first block.

For example, the encoder 237 may generate the conversion information CNV_info by determining whether an RGB data value is repeated between a plurality of pixel groups of a same size.

For example, the encoded display data ED[n,x,y] may include data including the repeated RGB data value and a repeating section.

For example, the pixel groups of the same size may belong to a same frame.

For example, the encoder 237 may generate the conversion information CNV_info by determining whether same display data is repeated between the pixel groups of the same size including gray display data. The pixel groups of the same size may belong to different frames.

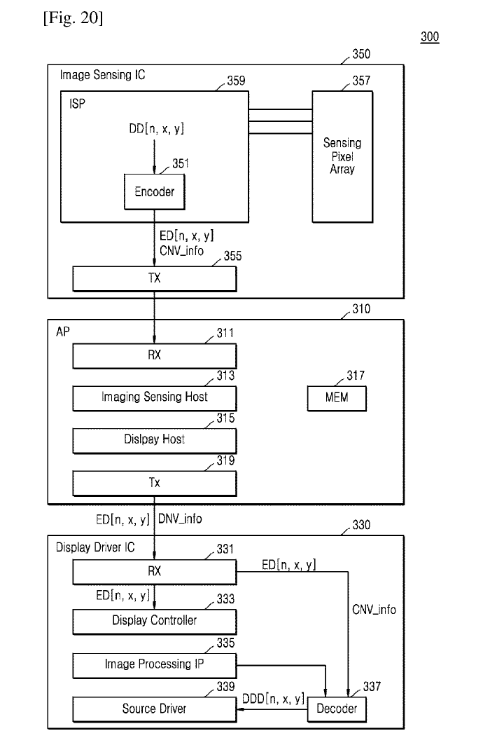

FIG. 20 is a block diagram of an electronic device 300 according to some embodiments of the present invention.

Referring to FIG. 20, the electronic device 300 may be included an electronic device having a display function and an image sensing function or an electronic device having a communication function. For example, the electronic device 300 may be a laptop computer, a mobile phone, a smart phone, a tablet PC, a PDA, an EDA, a digital still camera, a digital video camera, a PMP, a personal navigation device or PND, a handheld game console, an MID, or an e-book.

The electronic device 300 may include an AP 310, a display driver IC 330, and an image sensing IC 350.

The image sensing IC 350 may include an image sensing processor (ISP) 359, a sensing pixel array 357, and a transmission unit 355. The ISP 359 may include an encoder 351.

The sensing pixel array 357 may receive external incident light and convert a light signal into an electrical signal. The ISP 359 may receive the display data DD[n,x,y] as the electrical signal and generate the encoded display data ED[n,x,y] and the display data DD[n,x,y] by using the encoder 351.

The encoder 351 may receive the display data DD[n,x,y] (n denotes a serial number of a frame, a line, or a block, and x and y denote pixel address values) of each frame and determine the repeatability of the display data DD[n,x,y]. The encoder 351 may generate the conversion information CNV_info by determining the repeatability of the display data DD[n,x,y].

The encoder 351 may determine whether the current display data DD[n,x,y] repeats the display data DD[n−1,x,y] of a previous frame, line, and block and generate the conversion information CNV_info.

The encoder 351 may determine whether the display data DD[n,x,y] repeats the display data DD[n−1,x,y] having a difference below a reference value from the previous frame, line, and block.

The encoder 351 may generate the conversion information CNV_info by determining whether display data is the same between a plurality of pixel groups having the same size.

The encoder 351 may generate the conversion information CNV_info by determining whether RGB data values are repeated between the pixel groups having the same size.

In another embodiment, the encoder 351 may generate the conversion information CNV_info by determining whether a gray data value is repeated between pixel groups having the same size.

The encoder 351 may generate the encoded display data ED[n,x,y] by receiving the display data DD[n,x,y] and the conversion information CNV_info. For example, the encoder 351 may generate the encoded display data ED[n,x,y] by encoding the display data DD[n,x,y] based on repeatability information of a corresponding pixel, line, block, or frame included in the conversion information CNV_info. The encoder 351 may generate the encoded display data ED[n,x,y] in packet form.

The transmission unit 355 may transmit the conversion information CNV_info generated by the encoder 351 and the encoded display data ED[n,x,y] that are generated by the encoder 351 to the AP 310.

The AP 310 may generally control the electronic device 300. For example, when the electronic device 300 is an electronic device having a communication function, the AP 310 may perform near distance communication, determine location information of the electronic device 300, receive broadcasting, access wireless Internet, and recognize a user input.

The AP 310 may include a receiving unit 311, an image sensing host 313, a display host 315, a memory 317, and a transmission unit 319.

The image sensing host 313 may control the image sensing IC 350. The conversion information CNV_info and the encoded display data ED[n,x,y] that are received by the image sensing IC 350 may be stored in the memory 317. The display host 315 may control an operation of the display driver IC 330.

The AP 310 may transfer the conversion information CNV_info and the encoded display data ED[n,x,y] to the display driver IC 330 via the transmission unit 319.

The display driver IC 330 may include a receiving unit 331, a display controller 353, an image processing IP 335, a decoder 337, and a source driver 339.

The receiving unit 331 may receive the conversion information CNV_info and the encoded display data ED[n,x,y] via the transmission unit 319. The display driver IC 330 may drive a display panel (not shown) by using the conversion information CNV_info and the encoded display data ED[n,x,y] that are received via the receiving unit 331.

The display controller 333 may apply the encoded display data ED[n,x,y] to a gate driver (not shown) and the source driver 339 based on a synchronization signal. Although not shown, for example, the display controller 333 may control the gate driver (not shown) and the source driver 339 based on the synchronization signal by receiving decoding data DD[n,x,y] from the decoder 337.

The imaging processing IP 335 performs necessary signal processing by using digital encoded display data. Signal processing may include color interpolation, color correction, auto white balance, gamma correction, color saturation correction, formatting, bad pixel correction, hue correction, and the like. Although not shown, for example, the imaging processing IP 335 may perform various kinds of signal processing by receiving the decoding data DD[n,x,y] from the decoder 337.

The decoder 337 may generate the decoding data DD[n,x,y] by receiving the encoded display data ED[n,x,y] on which signal processing is performed by using various methods. For example, the decoder 337 may generate the decoding data DD[n,x,y] by receiving the conversion information CNV_info and decoding the encoded display data ED[n,x,y] by referring to the conversion information CNV_info.

The source driver 339 may receive the decoding data DD[n,x,y]. The source driver 339 may transmit voltage signals corresponding to the display data to the display panel by using gamma voltages output from a gamma circuit.

For example, operations of pixels of the display panel are controlled by control of the source driver 339, and thus an image corresponding to the display data transmitted from an AP may be displayed on the display panel.

The electronic device 300 according to some embodiments may encode the display data DD[n,x,y] by using the image sensing IC 350 and transmit a relatively small amount of data to the display driver IC 350. The electronic device 300 may reduce power consumed to transmit the data.

For example, the decoder 337 may generate the conversion information CNV_info by determining whether the display data is the same between a plurality of pixel groups having a same size.

For example, the decoder 337 may determine that the display data is the same between the pixel groups when the pieces of display data of the pixel groups having the same size have a difference below a reference value.

For example, the pixel groups may be pixel groups of a same line, pixel groups of a same frame, or pixel groups including pixel blocks including N number of horizontal pixels and M number of vertical pixels.

For example, the encoded display data ED[n,x,y] may include a command including at least one of data regarding a repeated pixel, whether to repeat a pixel, and a repeating method, and a header including a parameter including the data regarding the repeating method.

For example, the parameter may include data as to whether display data of a first pixel repeats display data of a second pixel neighboring the first pixel.

For example, the encoded display data ED[n,x,y] may include a body including data regarding display data that is not included in the header for each pixel.

For example, the parameter may include the data as to whether the display data of the first pixel repeats the display data of the second pixel neighboring the first pixel. The body may include the display data of the first pixel when the display data of the first pixel does not repeat the display data of the second pixel neighboring the first pixel.

For example, the decoder 337 may include a line comparator that generates the conversion information CNV_info for each line and a comparison value storage unit that stores a result of the determination of the line comparator.

For example, the decoder 337 may generate the conversion information CNV_info for blocks having a same size, determine whether display data of a first block and display data of a second block are the same, and generate conversion information for the first block.

For example, the encoded display data ED[n,x,y] may include data regarding a start point of the first block and an end point of the first block.

For example, the decoder 337 may generate the conversion information CNV_info by determining whether an RGB data value is repeated between a plurality of pixel groups of a same size.

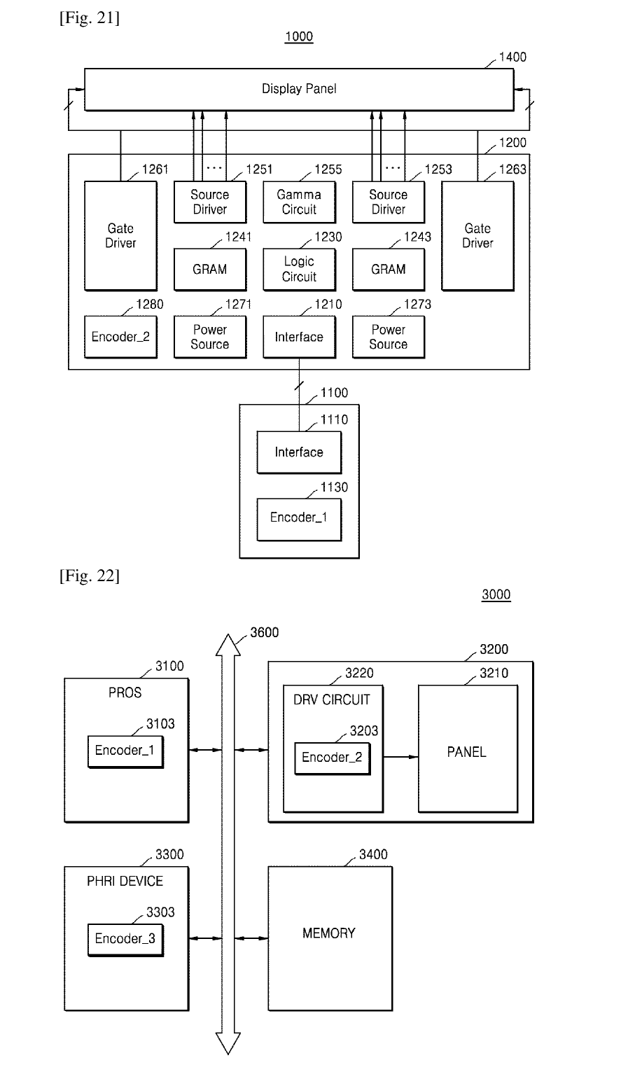

FIG. 21 is a block diagram of an electronic device 1000 according to some embodiments of the present invention.

Referring to FIG. 21, the electronic device 1000 may include a display driver IC 1200, an AP 1100, and a display panel 1400.

The electronic device 1000 may be implemented as a portable electronic device including the display panel 1400.

The display driver IC 1200 may display display data on the display panel 1400 according to control of a processor, for example, an AP. When the display driver IC 1200 is used in a mobile device, the display driver IC 1200 may be called a mobile display driver IC.

The display driver IC 1200 may include a serial interface 1210, a logic circuit 1230, and at least one graphic memory, i.e. graphics memories 1241 and 1243 The serial interface 1210 of the display driver IC 1200 may perform serial communication with a serial interface 1110 of the AP 1100.

The serial interfaces 1210 and 1110 may each be a serial interface, such as an MIPI interface (MIPI®), a mobile display digital interface (MDDI), a display port, or an embedded display port (eDP). For example, the serial interfaces 1210 and 1110 may each be an MIPI® or a display serial interface (DSI).

The graphics memories 1241 and 1243 may process (for example, store) image data or graphic data to be displayed on the display panel 1400. Although not shown in FIG. 21, a line buffer may be used instead of the graphics memories 1241 and 1243 according to another embodiment of the present invention.

The display driver IC 1200 may further include at least one source driver, i.e., source drivers 1251 and 1253, a gamma circuit 1255, at least one gate driver, i.e., gate drivers 1261 and 1263, and at least one power source, i.e., power sources 1271 and 1273.

In FIG. 21, the two source drivers 1251 and 1253, the gamma circuit 1255, the two gate drivers 1261 and 1263, and the two power sources 1271 and 1273 are illustrated, but a structure of the display driver IC 1200 according to the current embodiment of the present invention is not limited thereto.

The source drivers 1251 and 1253 may provide signals corresponding to image data or graphic data output from the graphics memories 1241 and 1243 to data lines of the display panel 1400, by using respective gamma voltages output from the gamma circuit 1255.

The gate drivers 1261 and 1263 may drive gate lines of the display panel 1400.

For example, since operations of pixels of the display panel 1400 are controlled by the source drivers 1251 and 1253 and the gate drivers 1261 and 1263, an image corresponding to the image data or graphic data output from the graphics memories 1241 and 1243 may be displayed on the display panel 1400.

The two power sources 1271 and 1273 may supply power to the serial interface 1210, the logic circuit 1230, the graphics memories 1241 and 1243, the source drivers 1251 and 1253, the gamma circuit 1255, the gate drivers 1261 and 1263, and the display panel 1400.

The AP 1100 according to some embodiments of the present invention may include a first encoder 1130. The first encoder 1130 may be implemented as the encoder 111 of FIG. 1. The display driver IC 1200 may include a second encoder 1280. The second encoder 1280 may be implemented as the encoder 237 of FIG. 19. The first encoder 1130 may firstly encode display data based on the repeatability determined by the first encoder 1130 and secondly encode the display data based on the repeatability determined by the second encoder 1280.

A relatively small amount of power may be used to transmit the display data to the display driver IC 1200.

FIG. 22 illustrates a display system 3000 according to an embodiment of the present invention.

Referring to FIG. 22, the display system 3000 may include a processor 3100, an electronic device 3200, a peripheral device 3300, and a memory 3400, which are electrically connected to a system bus 3600.

The processor 3100 controls inputting or outputting of data to or from the peripheral device 3300, the memory 3400, and the electronic device 3200 and may process an image of image data transferred between the peripheral device 3300, the memory 3400, and the electronic device 3200. The processor 3100 may include a first encoder 3103. The first encoder 3103 may encode image data based on a repeatability determination and transmit the encoded image data to other devices.

The electronic device 3200 includes a display panel 3210 and a driving circuit 3220, and may store image data received through the system bus 3600 in a frame memory included in the driving circuit 3220 and display the image data on the display panel 3210. The driving circuit 3220 may include a second encoder 3203. The second encoder 3203 may encode image data based on a repeatability determination and transmit the encoded image data to other devices.

The peripheral device 3300 may be a device that converts a video or a still image captured by a camera, a scanner, or a webcam to an electric signal. Image data obtained by the peripheral device 3300 may be stored in the memory 3400 or displayed on the display panel 3210 of the electronic device 3200 in real-time. The peripheral device 3300 may include a third encoder 3303. The third encoder 3303 may encode image data based on a repeatability determination and transmit the encoded image data to other devices.

The memory 3400 may include a volatile memory device, such as dynamic random access memory (DRAM), and/or a nonvolatile memory device, such as a flash memory. The memory 3400 may include DRAM, phase change RAM (PRAM), magnetic RAM (MRAM), resistance RAM (ReRAM), ferroelectric RAM (FRAM), a NOR flash memory, a NAND flash memory, or a fusion flash memory (for example, a memory in which a static RAM (SRAM) buffer, a NAND flash memory, and a NOR interface logic are combined). The memory 3400 may store image data obtained by the peripheral device 3300 or an image signal processed by the processor 3100.

The display system 3000 according to the present embodiment may include the electronic devices 3100, 3200, and 3300 that respectively include the first through third encoders 3103, 3203, and 3303, thereby transmitting image data at relatively low power when the image data is transmitted to the electronic devices 3100, 3200, and 3300 or internally.

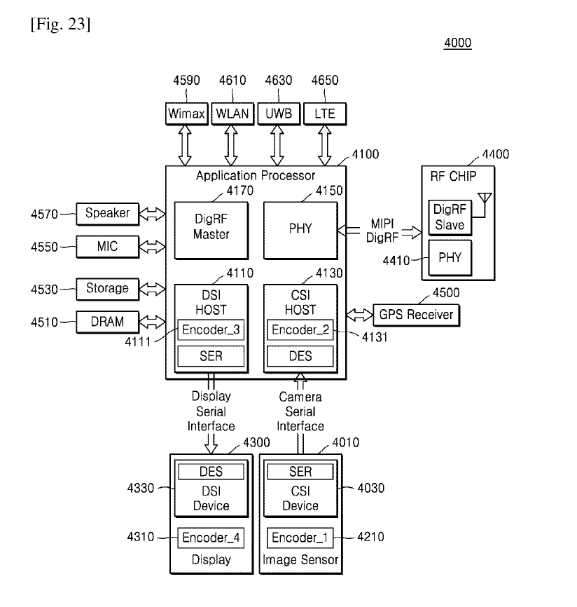

FIG. 23 is a block diagram of an electronic device 4000 according to another embodiment of the present invention.

Referring to FIG. 23, the electronic device 4000 having a communication function may be implemented as a portable electronic device that may use or support a mobile industry processor interface (MIPI).

The electronic device 4000 having a communication function may be implemented as an electronic device including a display 4300. The electronic device 4000 may be a display electronic device or an electronic device having a communication function that is described with reference to FIGS. 1 and 19 through 22.

The electronic device 4000 having a communication function may include an AP 4100, an image sensor 4010, and the display 4300.

The image sensor 4010 may receive an optical signal and convert the optical signal into an electrical signal. For example, the image sensor 4010 may convert an optical signal in a visible ray region into an electrical signal. According to another embodiment, the image sensor 4010 may be a time of flight (ToF) image sensor. The image sensor 4010 may include a first encoder 4210. The first encoder 4210 may encode image data based on a repeatability determination and transmit the encoded image data to other devices.

A camera serial interface (CSI) host 4130 included in the AP 4100 may serial-communicate with a CSI device 4030 of the image sensor 4010 through a CSI. The CSI host 4130 may include a second encoder 4131. The second encoder 4131 may encode image data based on a repeatability determination and transmit the encoded image data to other devices.

According to an embodiment, a deserializer (DES) may be included in the CSI host 4130 and a serializer (SER) may be included in the CSI device 4030.

A display serial interface (DSI) host 4110 included in the AP 4100 may serial-communicate with a DSI device 4330 of the display 4300 through a DSI. The DSI host 4110 may include a third encoder 4111. The third encoder 4111 may encode image data based on a repeatability determination and transmit the encoded image data to other devices.

According to an embodiment, an SER may be included in the DSI host 4110, and a DES may be included in the DSI device 4330. The DES and the SER may each process an electric signal or an optical signal.

The display 4300 may receive the image data from the DSI host 4110 and provide the image data via a display panel. The display 4300 may include a fourth encoder 4310. The fourth encoder 4310 may encode and use image data based on a repeatability determination to internally implement the encoded image data via the display panel.

The electronic device 4000 having a communication function may further include a radio frequency (RF) chip 4400 capable of communicating with the AP 4100. A physical layer (PHY) 4150 of the AP 4100 and a PHY 4410 of the RF chip 4400 may exchange data according to MIPI DigRF.

The electronic device 4000 having a communication function may further include a global positioning system (GPS) receiver 4500, a memory, such as DRAM 4510, a data storage unit 4530 that is a nonvolatile memory, such as a NAND flash memory, a microphone 4550, and a speaker 4570.

The electronic device 4000 having a communication function may communicate with an external device by using at least one communication protocol or communication standard, such as worldwide interoperability for microwave access (WiMAX) 4590, wireless LAN (WLAN) 4610, ultra-wideband (UWB) 4630, or long term evolution (LTE) 4650.

The electronic device 4000 may communicate with an external device by using Bluetooth or WiFi.

The electronic device 4000 having a communication function according to one or more embodiments of the present invention may use a relatively low amount of power while data is transferred between the AP 4100 and the DSI device 4330 and between the AP 4100 and the CSI device 4030.

For example, an encoder may generate conversion information by determining whether the display data is the same between a plurality of pixel groups having a same size.

For example, the encoder may determine that the display data is the same between the pixel groups when the pieces of display data of the pixel groups having the same size have a difference below a reference value.

For example, the pixel groups may be pixel groups of a same line, pixel groups of a same frame, or pixel groups including pixel blocks including N number of horizontal pixels and M number of vertical pixels.

For example, encoded display data may include a command including at least one of data regarding a repeated pixel, whether to repeat a pixel, and a repeating method, and a header including a parameter including the data regarding the repeating method.

For example, the parameter may include data as to whether display data of a first pixel repeats display data of a second pixel neighboring the first pixel.

For example, the encoder may include a line comparator that generates the conversion information for each line and a comparison value storage unit that stores a result of the determination of the line comparator.

For example, the encoder may generate the conversion information for blocks having a same size, determine whether display data of a first block and display data of a second block are the same, and generate conversion information for the first block.

For example, the encoded display data may include data regarding a start point of the first block and an end point of the first block.

For example, the encoder may generate the conversion information by determining whether an RGB data value is repeated between a plurality of pixel groups of a same size.

For example, the encoder may generate the conversion information by determining whether display data is the same between the pixel groups of the same size.

For example, the encoder may determine that the display data is the same between the pixel groups when the pieces of display data of the pixel groups having the same size have a difference below a reference value.

For example, the pixel groups may be pixel groups of a same line, pixel groups of a same frame, or pixel groups including pixel blocks including N number of horizontal pixels and M number of vertical pixels.

For example, encoded display data may include a command including at least one of data regarding a repeated pixel, whether to repeat a pixel, and a repeating method, and a header including a parameter including the data regarding the repeating method.

For example, the parameter may include data as to whether display data of a first pixel repeats display data of a second pixel neighboring the first pixel.

For example, the encoder may include a line comparator that generates the conversion information for each line and a comparison value storage unit that stores a result of the determination of the line comparator.

For example, the encoder may generate the conversion information for blocks having a same size, determine whether display data of a first block and display data of a second block are the same, and generate conversion information for the first block.

For example, the encoded display data may include data regarding a start point of the first block and an end point of the first block.

For example, the encoder may generate the conversion information by determining whether an RGB data value is repeated between a plurality of pixel groups of a same size.

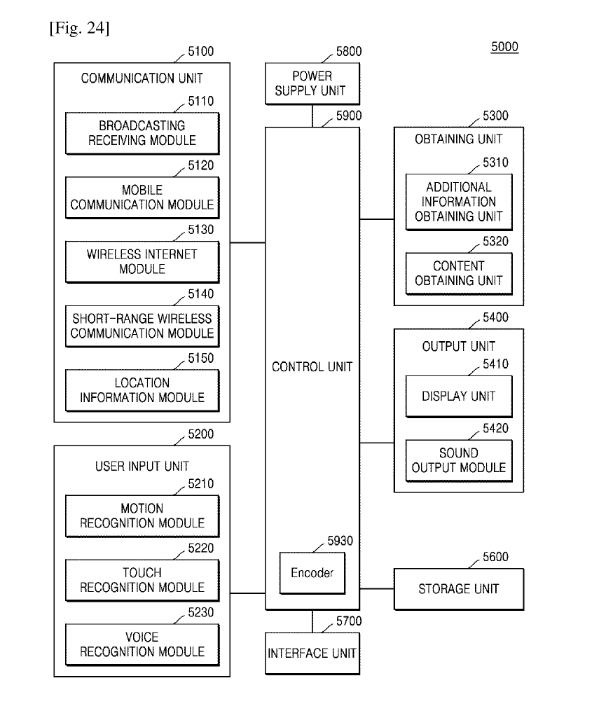

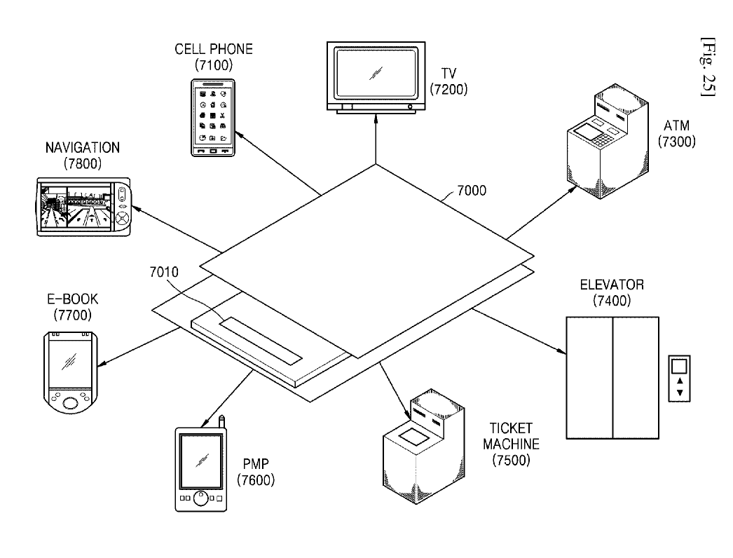

FIG. 24 is a block diagram of a mobile terminal 5000 according to some embodiments of the present invention.

Referring to FIG. 24, the mobile terminal 5000 according to some embodiments of the present invention may include a communication unit 5100, a user input unit 5200, an obtaining unit 5300, an output unit 5400, a storage unit 5600, an interface unit 5700, a power supply unit 5800, and a control unit 5900. However, these elements may not all be essential. The mobile terminal 5000 may be implemented with more or less elements than the elements of FIG. 24.

The above elements will now be sequentially described below.

The communication unit 5100 may include one or more elements for communication between the mobile terminal 5000 and another mobile terminal or between networks in which the mobile terminal 5000 and another mobile terminal are included. For example, the communication unit 5100 may include a broadcasting receiving module 5110, a mobile communication module 5120, a wireless Internet module 5130, a short-range wireless communication module 5140, and a location information module 5150.

The broadcasting receiving module 5110 may receive a broadcasting signal and/or broadcasting information from an external broadcasting management server over a broadcasting channel.

The mobile communication module 5120 may transmit or receive a wireless signal to or from a base station, an external electronic device, and servers over a mobile communication network. In this regard, the wireless signal may include a voice call signal, a conference call signal, or various types of data according to transmission and reception of text and multimedia messages.

The wireless Internet module 5130 refers to a module for wireless Internet access and may be included in or excluded from the mobile terminal 5000.

The short-range wireless communication module 5140 refers to a module for short-range wireless communication. A short-range wireless communication technology may include Wi-Fi, Bluetooth, ZigBee, WFD, UWB, IrDA, etc., but the present invention is not limited thereto.

The location information module 5150 is a module for confirming or obtaining a location of the mobile terminal 5000. An example of the location information module 5150 may be a global positioning system (GPS) module. The GPS module receives location information from a plurality of satellites. In this regard, the location information may include coordinate information indicated by latitude and longitude.

The user input unit 5200 is a unit that allows the user to input data for controlling the mobile terminal 5000. For example, the user input unit 5200 may include a key pad, a dome switch, a touch pad (a contact-type electrostatic capacitive method, a pressure resistive layer method, an infrared ray sensing method, a surface ultrasonic wave conduction method, an integration-type tension measurement method, a piezoelectric effect method, or the like), a jog wheel, a jog switch, or the like.

The user input unit 5200 may include at least one module for receiving an input of data from the user. For example, the user input unit 5200 may include a motion recognition module 5210, a touch recognition module 5220, a voice recognition module 5230, etc.

The motion recognition module 5210 may recognize a movement of the mobile terminal 5000 and transfer information regarding the movement of the mobile terminal 5000 to the control unit 5900.

The touch recognition module 5220 may sense a touch gesture on a touch screen of the user and transfer information regarding the touch gesture to the control unit 5900.

The voice recognition module 5230 may recognize a user's voice by using a voice recognition engine and transfer the recognized user's voice to the control unit 5900.

The obtaining unit 5300 may obtain data from the outside. The obtaining unit 5300 may include an additional information obtaining unit 5310 and a content obtaining unit 5320.

If link information of additional information is received, the additional information obtaining unit 5310 may access a server to obtain the additional information based on the link information of the additional information.

If link information of content is received, the additional information obtaining unit 5310 may access the server to obtain the content based on the link information of content.

The output unit 5400 is used to output an audio signal, a video signal, or an alarm signal. The output unit 5400 may include a display unit 5410, a sound output module 5420, etc.

The display unit 5410 displays information processed by the mobile terminal 5000.

The display unit 5410 may include the display driver ICs 130, 230, 330 according to some embodiments of the present invention.

In a case where the display unit 5410 and a touch pad have a layer structure and are configured as a touch screen, the display unit 5410 may be used as an input unit, as well as an output unit. The output unit 5400 may include two or more display units 5410 according to an implementation type of the mobile terminal 5000.

The sound output module 5420 receives a call signal and outputs audio data that is received from the communication unit 5100 or that is stored in the storage unit 5600 in a calling or recording mode, a voice recognition mode, a broadcasting reception mode, etc.

The storage unit 5600 may store a program for processing or controlling the control unit 5900. The storage unit 5600 may perform a function of storing input and output data.

The storage unit 5600 may include at least one storage medium selected from the group consisting of flash memory, hard disk-type memory, multimedia card micro-type memory, card-type memory (for example, SD memory, XD memory, or the like), random access memory (RAM), static RAM (SRAM), read-only memory (ROM), electrically erasable programmable read-only memory (EEPROM), programmable ROM (PROM), magnetic memory, a magnetic disk, and an optical disk.

The interface unit 5700 interfaces with all external devices connected to the mobile terminal 5000. For example, the interface unit 170 may include a wired/wireless headset port, an external charger port, a wired/wireless data port, a memory card port, a port for connecting an apparatus including an identification module, an audio input/output (I/O) port, a video I/O port, an earphones port, etc.

In this regard, the identification module is a chip for storing various types of information used to authenticate a user of the mobile terminal 5000 and may include a user identity module (UIM), a subscriber identity module (SIM), a universal subscriber identity module (USIM), etc.

The power supply unit 5800 supplies power necessary for operations of elements by receiving internal and external power under the control of the control unit 5900.

The control unit 5900 controls the overall operation of the mobile terminal 5000. That is, the control unit 5900 may generally control the communication unit 5100, the user input unit 5200, the obtaining unit 5300, the output unit 5400, the storage unit 5600, the interface unit 5700, and the power supply unit 5800.

The control unit 5900 according to some embodiments of the present invention may include an encoder 5930. The encoder 5930 may determine the repeatability of image data and/or sound data that is input, output, and processed, and encode the image data and/or sound data based on the determined repeatability. The control unit 5900 may use the encoded display data to transmit data to other elements.

Although not shown, other elements (for example, the communication unit 5100, the user input unit 5200, the obtaining unit 5300, the output unit 5400, the storage unit 5600, the interface unit 5700, and the power supply unit 5800) may determine the repeatability of the image data and/or the sound data and encode the image data and/or sound data based on the determined repeatability to internally use the encoded display data or transmit or receive the encoded display data to or from the control unit 5900.

The mobile terminal 5000 according to some embodiments of the present invention may use a relatively small amount of power to transmit data between the control unit 5900 and other elements (for example, the communication unit 5100, the user input unit 5200, the obtaining unit 5300, the output unit 5400, the storage unit 5600, the interface unit 5700, and the power supply unit 5800).

FIG. 25 is a diagram of application examples of various electronic products on which an electronic device 7000 is mounted, according to embodiments of the present invention.

The electronic device 7000 according to one or more embodiments of the present invention may be employed in any one of various electronic products, such as a cell phone 7100, a TV 7200, an automated teller machine (ATM) 7300, an elevator 7400, a ticket machine 7500 used in subways or the like, a PMP 7600, an e-book 7700, and a navigation system 7800.

A display driver IC of the electronic device 7000 according to one or more embodiments of the present invention may drive a display panel by receiving downsized conversion data from an AP of a system. Thus, by using the electronic device 7000, power consumption of a processor may be reduced such that the processor is quickly driven on lower power, thereby improving the performance of an electronic product.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

1. An electronic device comprising:
an application processor (AP) comprising an encoder configured to determine repeatability of display data, to generate conversion information based on the repeatability of display data, to encode the display data based on the repeatability of display data, and to generate encoded display data with the conversion information; and
a display driver integrated circuit (IC) configured to receive the encoded display data with the conversion information and to drive a display panel according to the encoded display data based on the conversion information.

2. The electronic device of claim 1, wherein the display driver IC comprises:
a decoder configured to reconstruct the encoded display data corresponding to the conversion information; and
a source driver configured to receive the display data reconstructed by the decoder.

3. The electronic device of claim 1, wherein the encoder determines whether display data is the same between a plurality of pixel groups having a same size to generate the conversion information.

4. The electronic device of claim 3, wherein the encoder determines that the display data is the same between the plurality of pixel groups when a difference between display data corresponding to each of the plurality of pixel groups having the same size is below a reference value.

5. The electronic device of claim 3, wherein the plurality of pixel groups comprise pixel groups of a same line, pixel groups of a same frame, or pixel groups including pixel blocks including N number of horizontal pixels and M number of vertical pixels.

6. The electronic device of claim 1, wherein, the encoded display data comprises:
a command comprising at least one of data regarding a repeated pixel, whether to repeat a pixel, and a repeating method; and
a header comprising a parameter including the data regarding the repeating method.

7. The electronic device of claim 6, wherein the parameter comprises data as to whether display data of a first pixel repeats display data of a second pixel neighboring the first pixel.

8. The electronic device of claim 7, wherein the encoded display data comprises a body comprising data regarding display data that is not included in the header for each pixel.

9. The electronic device of claim 8, wherein the parameter comprises the data as to whether the display data of the first pixel repeats the display data of the second pixel neighboring the first pixel, and
wherein the body comprises the display data of the first pixel when the display data of the first pixel does not repeat the display data of the second pixel neighboring the first pixel.

10. The electronic device of claim 8, wherein the encoded display data comprises a tail comprising a parity check code for checking completeness of the encoded display data.

11. The electronic device of claim 1, wherein the encoder comprises:
a line comparator configured to generate the conversion information for each line; and
a comparison value storage configured to store a result of the determination of the line comparator.

12. The electronic device of claim 1, wherein the encoder generates the conversion information for blocks having a same size,
wherein the encoder generates the conversion information for the first block by determining whether display data of a first block and display data of a second block are the same.

13. The electronic device of claim 1, wherein the encoder generates the conversion information by determining whether an RGB data value is repeated between a plurality of pixel groups of a same size.

14. The electronic device of claim 1, wherein the encoder generates the conversion information by determining whether same display data is repeated between the plurality of pixel groups of the same size comprising gray display data.

15. A display driver integrated circuit (IC) comprising an encoder configured to determine repeatability of display data, to generate conversion information based on the repeatability of display data, to encode the display data based on the repeatability of display data, and to generate encoded display data with the conversion information, wherein the display driver IC receives the encoded display data with the conversion information and drives a display panel according to the encoded display data based on the conversion information.
